(19) United States
(12) Patent Application Publication
(10) Pub. No.: US 2014/0314962 A1
(43) Pub. Date: Oct. 23, 2014

(54) HIGH PERFORMANCE FABRIC RELEASE COMPOSITION AND USE THEREOF

(71) Applicant: HERCULES INCORPORATED, Wilmington, DE (US)

(72) Inventors: Doeung David Choi, Hockessin, DE (US); Davit E. Sharoyan, Hockessin, DE (US); Christopher P. Dilkus, Woodlynne, NJ (US)

(73) Assignee: HERCULES INCORPORATED, Wilmington, DE (US)

(21) Appl. No.: 14/253,936

(22) Filed: Apr. 16, 2014

Related U.S. Application Data
(60) Provisional application No. 61/813,289, filed on Apr. 18, 2013.

(51) Int. Cl. D06M 13/473; B05D 5/08

(52) U.S. Cl. CPC D06M 13/473; B05D 5/08
USPC 427/421.1; 106/287.21

(57) ABSTRACT

The current invention provides for a composition and method for the improvement of fabric release in applications such as tissue and towel making processes. The method comprises treating the surface of a fabric in structured sheet making applications using compositions containing hydrophobic quaternary amines in combination with other hydrophobes and surfactants.

This application claims the benefit of U.S. Patent Application No. 61/813,286, Filed 18 Apr. 2013, the entire contents of which are hereby incorporated by reference.

### FIELD OF THE INVENTION

The present invention provides for a composition and method for the improvement of fabric release in applications such as tissue and towel making processes. The method comprises treating the surface of a fabric in structured sheet making applications of a tissue machine using compositions containing hydrophobic quaternary amines in combination with other hydrophobes and surfactants.

### BACKGROUND OF THE INVENTION

A tissue making process for the manufacture of products such as facial tissue, bathroom tissue and paper towels consists of the formation of a wet tissue sheet from an aqueous slurry of pulp and chemical additives followed by the removal of water from the wet tissue. Water removal can be accomplished by pressing the wet tissue onto, for example, a Yankee cylinder or Yankee drier, which terms are used interchangeably herein. Until recently, tissue paper was produced on Dry Crepe Crescent Formers and Through Air Drying (TAD) processes. Through air drying (TAD) processes include transfer of a paper web onto a TAD fabric, which has a 3-dimensional character and gives the wet sheet structure and pattern, so that when dry, the pattern remains in the tissue. This is accomplished through a transfer of hot air through the wet tissue providing for water removal and drying the sheet. The structured or patterned tissue is then transferred to a Yankee cylinder for further drying and creping. Through air drying (TAD) processes allows for a generation of higher quality tissue with increased bulk and softness, higher strength and absorption.

Upon the reduction of water content fibers come into close proximity with each other and the degree of association and bonding grows significantly. Fibers not only adhere to each other but also tend to adhere to the fabric. Increased tissue adhesion onto the fabric surface is not desirable since it may affect the sheet structure, result in formation of fiber deposits on the fabric surface and create complications in tissue release from the fabric and its further transfer to, for example, the Yankee drier. To avoid these undesirable effects, a number of treatments have been utilized including modifications in fabric cover materials, and/or application of various fabric release agents to aid in the separation of the tissue from the fabric. Fabric release agents are generally applied to the fabric surface prior to transfer of the sheet from a forming fabric to the release fabric.

Recent advances in the area of tissue manufacture offer the high bulk of a TAD process and the speed and energy efficiency of Dry Crepe Tissue (DCT). Processes such as Metso's NTT process and Voith's Advance Tissue Molding System (ATMOS) process which use a textured or structured fabric or belt.

Hydrophobic materials such as silicone oil, mineral and vegetable oils, and polyalphaolefins have been used in treating TAD fabric. The applications of these chemistries are not always simple and straightforward since hydrophobic materials are being added to an aqueous system. In many cases these hydrophobic materials are mixed with surfactants. Addition of surfactants, such as non-ionic surfactants, to hydrophobic materials has beneficial effects since the surfactant helps in emulsifying the hydrophobic materials (e.g. mineral oils) and promotes more efficient delivery and spread of hydrophobes on surfaces such as TAD fabric or Yankee dryer surfaces and could have beneficial effects on metal, fiber, and other surfaces.

U.S. Pat. No. 8,071,667 teaches one or more (poly)C₅-C₂₀ alpha olefins in combination with one or more surfactants for use in releasing a paper web from the fabric in through air drying processes and/or from a Yankee dryer. The claimed compositions comprise between 99% and 60% alpha olefins and 1% to 40% surfactants.

U.S. Patent Application No. 2005/0241791 discloses a method of making a cellulosic tissue sheet by treating the web surface of the tissue machine with a chemical debonding agent. The chemical debonding agent comprises an oleyl imidazolium compound. The composition further contains a lubricant and a surfactant. The composition is applied to the tissue web and the chemical debonding agent is distributed though the entire thickness of the web by subjecting the web to vacuum suction. It is suggested that the composition is applied to the web between a rush transfer and the through-air drying operation or between first and second through-air drying operations.

Each reference cited in the present application including books patents, published applications, journal articles and other publications, is incorporated herein by reference in their entirety.

### SUMMARY OF THE INVENTION

The present invention relates to compositions and methods for reducing the adhesion between a tissue web and surfaces such as structured or textured fabric, belts, plates or rolls used in tissue production processes hence improving the release of the tissue web from, for example, the TAD fabric surface. The method comprises the application of a composition comprising hydrophobic aminoamide quats in combination with a) at least one hydrophobic component other than an aminoamide, c) one or more surfactants and/or mixtures thereof to, for example, a TAD fabric surface, a structured fabric surface, a papermaking belt surface, a textured or structured belt surface, plate cylinder or roll surfaces or the surface of a Yankee drier.

In one embodiment, the present invention also relates to a method of reducing paper adhesion to fabric surfaces by applying a composition of cyclyzed or linear quaternized hydrophobic aminoamides or mixtures thereof, mineral oil; and a surfactant to the fabric surface. The proposed formulations can be applied by sprays or roller applicators to the surfaces of interest.

### DETAILED DESCRIPTION OF THE INVENTION

The present invention relates to compositions and methods that can be used for the reduction of adhesion between forming tissue web and fabric surfaces. The composition comprising hydrophobic amines, such as low molecular weight hydrophobic imidazolines and non-cyclic hydrophobic aminoamide quats and/or mixtures thereof, with at least one of a) another hydrophobic component such as mineral and vegetable oils and/or b) surfactants such as linear, polyethylene glycol esters, mono- and di-esters of various fatty acids such as, oleic, stearic and palmitic acids and c) mixtures thereof.

The invention also relates to applying a hydrophobic composition or aqueous emulsion to a surface of a tissue machine thus reducing the adhesion of the tissue to the fabric and improves tissue release.

It is also envisioned that the composition of the present invention can be used on surfaces in other tissue applications such as treatment of structured fabric, textured/structured belts, plates or rollers. For example, the textured belts in Metro's NTT process or the structured or textured rolls used in Voith's Advance Tissue Molding System (ATMOS) process.

The term “hydrophobic amines” are defined as any low molecular weight amine or ammonium containing compound with the nitrogen of an amine or ammonium group bound to a hydrophobic or fatty group such as a hydrocarbon or fluorocarbon chain. The amines can be linear or branched fatty alkyl amities, ammonium compounds, cyclic imidazolines, linear aminoamides, and the like.

The low molecular weight hydrophobic amines of the present invention were found to be very efficient in reducing adhesion of tissue paper to, for example TAD fabric and for TAD fabric release applications. Hydrophobic amines include, for example, quaternized aminoamides and/or quaternized imidazoline cyclic structures with one or two hydrophobic groups attached and mixtures thereof. The composition can comprise quaternized linear aminoamides; quaternized cyclic imidazolines and/or mixtures thereof.

The following Formula I and Formula II are representative of the quaternized aminoamides that can be used in the present invention:

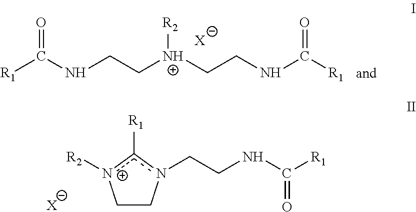

wherein
R₁ can be a saturated or unsaturated, linear or branched, C₁₂-C₂₂ aliphatic groups and can be C₁₆-C₁₈ aliphatic groups
R₂ can be a methyl- or ethyl-group; and
X can be a counter ion such as an ethylsulfate or methylsulfate.

The amines of the present invention were produced by a reaction between fatty acids (e.g. oleic acid, palmitic acid, or stearic acid) with di-ethylenetriamine or aminoethylethanolamine and subsequent quaternization of the resulting aminoamides by di-ethylsulfate, di-methylsulfate or acetic acid. The number of hydrophobic chains depends on the ratio of fatty acid and amine, and can be in a ratio of from about 1:1 and can be in a ratio of about 2:1.

The degree of cyclization or ring closure of the imidazoline quaternized products depends on reaction conditions. Under specific conditions it can be up to about 90% cyclized. In other cases it can be as little as 10% cyclized, resulting in a mixture of cyclized imidazoline quats and linear aminoamide quats. Imidazolines and non-cyclic aminoamide quats absorb strongly to negatively charged surfaces of materials such as fabrics, metals, and fibers, to make them hydrophobic.

The term “mineral oil”, is defined to mean oils from mineral sources and can be a mixture of linear, branched and aromatic hydrocarbons, paraffins, and waxes. The term “surfactants or non-ionic surfactants”, is used to define compositions comprising but not limited to, glycol and mono- and di-esters of various fatty acids. Other examples of non-ionic surfactants can include, for example, linear or branched alcohol ethoxylates, alcohol alkoxylates, polyoxyethylene-polyoxypropylene block copolymers, aliphatic polyethers, ethoxylated polymethylalkylsiloxanes, alkyl polyglucoside, ethoxylated sorbitans derivatives, sorbitans fatty acid esters, alkyl phenyl ethoxylates, and alkoxylated amines.

We have found through extensive investigation that mixtures of quaternized imidazolines and aminoamides are more effective in reducing the adhesion between a tissue web and a TAD fabric surface than mineral oils, poly-alphaolefins and other hydrophobic materials typically used in TAD fabric release applications. We have also found that quaternized imidazolines and aminoamides in combination with additional hydrophobic materials such as mineral or vegetable oils are more effective in TAD fabric release applications as compared with compositions containing the individual components.

Through this work we found that imidazoline and aminoamide quats are more effective in fabric release applications than alpha olefins and mineral oil. Therefore, one would assume that an increase in alpha olefins or mineral oil content in formulations with imidazoline quats would reduce the effectiveness of the imidazoline quat-mineral oil mixture. However, we have found that fabric release improves when the surface of a fabric is treated with a composition containing a mixture of quaternized aminoamides and at least one other hydrophobic component other than an aminoamide, such as for example mineral oil, wherein the other hydrophobic component comprises up to about 60% by wt. of the total composition and can comprise from about 5% to about 40% by wt. of the total composition. Enhancement of TAD fabric release with addition of the mineral oil to the mixture of the quaternized aminoamide was totally unexpected. Additionally, it was found that combinations of the quaternized aminoamide with at least one other hydrophobic active besides an aminoamide; and a non-ionic surfactant, cause a reduction of adhesion between the tissue web and TAD fabric.

In one embodiment, a through air drying (TAD) fabric release composition comprising quaternized aminoamide(s); at least one hydrophobic component other than an aminoamide; and optionally a non-ionic surfactant(s); wherein the quaternized aminoamides are low molecular weight imidazoline and non-cyclic aminoamide quats and/or mixtures thereof and comprises from 20% to 99% by weight of the total composition and can comprise from about 40%-75% by wt. of total composition; wherein the at least one hydrophobic component is mineral oil, vegetable oil, silicon oil, polyalphaolefins and/or mixtures thereof comprising up to 60% by weight of the total composition and can be from about 5% to about 40% by wt. of the total composition; wherein the surfactant is glycol and/or esters thereof; mono- and di-esters of fatty acids; and/or mixtures thereof; and wherein the non-ionic surfactant comprises from 0% to about 40 and can be from about 10% to about 30% by wt. of the total composition.

In another embodiment a formulation comprising a) a mixture of hydrophobic imidazoline, and hydrophobic non-cyclic aminoamide, b) mineral oil and c) polyethylene glycol di-esters, such as oleic, stearic and palmitic acids; is used to reduce the adhesion between tissue and TAD fabric.

In another embodiment, the composition can be used to improve tissue release in tissue making processes such as in tissue mills for Yankee release applications.

The present invention will now be described with reference to a number of specific examples that are to be regarded as illustrative and not restricting the scope of the present invention.

### EXAMPLES

The present compositions were evaluated for their ability to reduce adhesion of wet tissue to TAD fabric materials. A number of formulations were tested on a TAD Fabric Release tester designed by Hercules Inc to measure the affects of the compositions on resultant forces of adhesion and a Zwick release test (see Choi, D. D., “New Simulation Capability Turns Art into Science for Structured Tissue and Towel Making Processes,” Proceedings of Tissue 360 Forum, PaperCon 2013, 2013). The formulations were tested as aqueous solutions with levels of treatments at 60 mg/m² and 120 mg/m².

Imidazolines listed in the Tables 1A, 1B and 1C below include the following:

Imidazoline A, is a mixture of cyclized imidazoline and linear mono- and bis-amides formed from the reaction of oleic acid and diethylenetriamine (with 2:1 ratio), quaternized with dimethyl sulfate.

The efficacies of the present compositions were determined by comparing the results of experiments performed on TAD fabric surfaces treated with the present composition versus blank experiments wherein the TAD fabric surfaces were not treated with the compositions of the present invention.

Table 1 summarizes the results, which are reported as absolute values of adhesion force for the blanks (untreated surfaces) and treated surfaces (columns 3 and 4) as well as relative effects expressed in % reduction vs. blank treatment (columns 5 and 6). The data presented is an average of 6 measurements per treatment.

### Example #1

A. A number of experiments on TAD Fabric Release were done using mixtures of Imidazoline A; mineral oil and a non-ionic surfactant as described above. The content of non-ionic surfactant was kept constant at 20% and the amount of Imidazoline A and mineral oil were varied from 0% to 80%. The mixtures were tested for TAD fabric release at 60 mg/m² and 120 mg/m² addition levels.

B. A second set of experiments were accomplished wherein the amount of non-ionic surfactant in the mixture was 10% and kept constant. The amount of Imidazoline A and mineral oil were varied from 0% to 90%. The mixtures were tested for TAD fabric release at 60 mg/m² and 120 mg/m² addition levels using the test methods referenced above.

C. A third set of experiments were done wherein the amount of non-ionic surfactant in the mixture was 4% and kept constant. The amount of Imidazoline A and mineral oil were varied from 0% to 96%. The mixtures were tested for TAD fabric release at 60 mg/m² and 120 mg/m² addition levels using the test methods referenced above.

### Tables 1A, 1B and 1C

TABLE 1A
PEG 400 DO - 20%

| Imidazoline | Mineral | Adhesion, | Adhesion, | Adhesion reduction, | |
|---|---|---|---|---|---|
| A | oil | N | N | % | |
| % | % | 120 mg | 60 mg | 120 mg | 60 mg |
| 0 | 0 | 29.72 | 29.72 | | |
| 80 | 0 | 14.55 | 19.99 | 51.04 | 32.74 |
| 60 | 20 | 12.98 | 16.42 | 56.33 | 44.75 |
| 40 | 40 | 11.94 | 15.70 | 59.82 | 47.17 |
| 20 | 60 | 13.83 | 19.02 | 53.26 | 36.01 |
| 0 | 80 | 19.48 | 23.85 | 34.45 | 19.17 |

TABLE 1B
PEG 400 DO - 10%

| Imidazoline | Mineral | Adhesion, | Adhesion, | Adhesion reduction, | |
|---|---|---|---|---|---|
| A | oil | N | N | % | |
| % | % | 120 mg | 60 mg | 120 mg | 60 mg |
| 0 | 0 | 26.05 | 24.36 | | |
| 90 | 0 | 16.40 | 15.49 | 37.04 | 36.41 |
| 75 | 15 | 14.02 | 16.11 | 46.18 | 33.87 |
| 60 | 30 | 13.39 | 14.34 | 48.60 | 41.13 |
| 45 | 45 | 13.88 | 13.64 | 46.72 | 44.01 |
| 30 | 60 | 14.22 | 17.54 | 45.41 | 28.00 |
| 15 | 75 | 15.22 | 19.34 | 41.57 | 20.61 |
| 0 | 90 | 20.40 | 18.60 | 21.69 | 23.65 |

TABLE 1C
PEG 400 DO - 4%

| Imidazoline | Mineral | Adhesion, | Adhesion, | Adhesion reduction, | |
|---|---|---|---|---|---|
| A | oil | N | N | % | |
| % | % | 120 mg | 60 mg | 120 mg | 60 mg |
| 0 | 0 | 33.14 | 28.76 | | |
| 96 | 0 | 17.56 | 24.00 | 47.01 | 16.55 |
| 80 | 16 | 16.90 | 22.42 | 49.00 | 22.05 |
| 64 | 32 | 15.42 | 23.26 | 53.49 | 19.12 |
| 48 | 48 | 17.97 | 23.62 | 47.78 | 17.88 |
| 32 | 64 | 18.76 | 24.36 | 43.38 | 15.29 |
| 16 | 80 | 21.32 | 25.03 | 35.67 | 12.99 |
| 0 | 96 | 25.31 | 26.63 | 23.63 | 7.41 |

In respect to individual components mixed with fixed amounts of surfactant, it can be seen that Imidazoline A is more efficient than mineral oil in TAD fabric release tests. Adhesion values for Imidazoline A were lower than those of mineral oil. It can also be observed from the Examples above in all three testing cases that mixtures of Imidazoline A with mineral oil were more efficient than Imidazoline A by itself.

For example, in series with 20% surfactant in each formulation the adhesion values from mixtures with 80% Imidazoline A and 80% mineral oil are 14.55 and 19.48 N, respectively. Hence for the mixture containing 40% Imidazoline A and 40% mineral oil one might expect the adhesion value to be around 17.02 N. In fact the adhesion value is 11.94 N which is 29.8% lower than the expected value. Similarly, in the series with 4% surfactant the adhesion values for 96% Imidazoline A and 96% mineral oil are 17.56 and 25.31 N, respectively. The adhesion value for a mixture containing 64% Imidazoline A and 32% mineral oil is 15.42 N, which is 20.3% lower than expected from the adhesion values of individual components. The enhancement in performance of the imidazoline when mixed with the less efficient component, mineral oil, was totally unexpected.

It was also seen that the percentage range for Imidazoline A and mineral oil within which enhancement of fabric release was observed changed depending on whether a surfactant was used and the surfactant load. The range of enhancement is defined as the % range of the mixtures of mineral oil and Imidazoline A that had lower adhesion as compared with Imidazoline A alone. For example, enhancement of fabric release was found to be in the range of 20% to 60% Imidazoline A for formulations with 20% surfactant, from 30% to 75% Imidazoline A for formulations with 10% surfactant and from 48% to 80% Imidazoline A for formulations with 4% surfactant. Overall, enhancement of fabric release was observed over a range of formulations containing from about 20% to about 80% Imidazoline A. Additional enhancement was seen when the formulations contained from about 40% to about 75% Imidazoline A.

### Example #2

Comparative testing was run on a TAD fabric release tester with three formulations. Results can be seen in Table 2. Samples tested were a control having no treatment; Product B was made according to the present invention, which is a three component formulation containing Imidazoline A, mineral oil and a non-ionic surfactant. These were tested next to mineral oil/surfactant and poly-alphaolefin/surfactant two component formulations. Testing results demonstrated that Product B having Imidazoline A as a component significantly outperforms mineral oil and poly-alphaolefine formulations in adhesion reduction.

TABLE 2

| | Adhesion, N | | Adhesion reduction, % | |
|---|---|---|---|---|
| Product/Formulation | 60 mg/m2 | 120 mg/m2 | 60 mg/m2 | 120 mg/m2 |
| No treatment | 29.06 | 27.05 | | |
| Product B | 17.79 | 13.13 | 38.77 | 51.47 |
| Mineral oil/Surfactant | 24.01 | 21.13 | 17.39 | 21.89 |
| PAO/Surfactant | 26.64 | 25.63 | 8.34 | 5.24 |

While the present invention has been described with respect to particular embodiments thereof, it is apparent that numerous other forms and modifications will be obvious to those skilled in the art. The invention described in this application generally should be construed to cover all such obvious forms and modifications, which are within the true scope of the present invention.

We claim:

1. A fabric release composition comprising:
a) hydrophobic quaternized aminoamide(s);
b) at least one hydrophobic component other than an aminoamide; and
c) optionally a surfactant(s);
wherein the hydrophobic quaternized aminoamide(s) comprises from about 20% to about 99% by weight of the total composition; and
wherein the at least one hydrophobic component is mineral oil, vegetable oil, silicon oil, polyalphaolefins and/or mixtures thereof and comprises up to 60% by weight of the total composition.

2. A fabric release composition comprising:
a) hydrophobic quaternized aminoamide(s);
b) at least one hydrophobic component other than an aminoamide; and
c) optionally a surfactant(s);
wherein the quaternized aminoamide(s) is a low molecular weight imidazoline having the structure of Formula I; 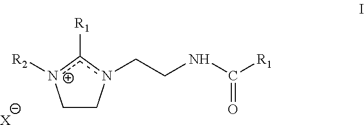
or
a non-cyclic aminoamides having the structure of Formula II; 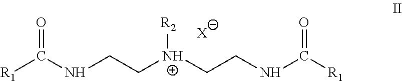
and mixtures thereof; wherein
R₁ is a linear or branched, saturated or unsaturated, C₁₂-C₂₂ aliphatic group;
R₂ is a methyl- or ethyl-group; and
X is counter ion;
wherein the hydrophobic quaternized aminoamide(s) comprises from about 20% to about 99% by weight of the total composition; and
wherein the at least one hydrophobic component is mineral oil, vegetable oil, silicon oil, polyalphaolefins and/or mixtures thereof and comprises up to 60% by weight of the total composition.

3. The composition according to claim 2, wherein the counter ion is ethylsulfate or methylsulfate.

4. The composition according to claim 2, wherein R₁ is a linear or branched, saturated or unsaturated, C₁₆-C₁₈ aliphatic group.

5. The composition according to claim 1, wherein the at least one hydrophobic component is mineral oil; vegetable oil; or mixtures thereof.

6. The composition according to claim 1, wherein the at least one hydrophobic component other than an aminoamide comprises from about 5% to about 40% based on weight of total composition.

7. The composition according to claim 1, wherein the optional non-ionic surfactant is glycol and/or ester thereof; mono- and di-esters of fatty acids; and/or mixtures thereof.

8. The composition according to claim 1, wherein the optional non-ionic surfactant comprises less than 40% by wt. of the total composition.

9. The composition of claim 1, wherein the aminoamides are selected from the group consisting of low molecular weight hydrophobic cyclic imidazolines, non-cyclic hydrophobic aminoamide quats, and mixtures thereof.

10. The composition according to claim 1, wherein the cyclic imidazolines between about 10% and 90% cyclized.

11. The composition according to claim 7, wherein the non-ionic surfactant is a glycol diester selected from the group consisting of oleic, stearic and palmitic acids.

12. A method for reducing the adhesion between a tissue web and a fabric surface comprising:
providing a composition comprising
a) hydrophobic cyclic and/or linear quaternized aminoamides;
b) at least one hydrophobic component other than an aminoamide; and
c) optionally a surfactant(s);
wherein the quaternized aminoamides are low molecular weight imidazoline and non-cyclic aminoamide quats and/or mixtures thereof and comprises from 20% to 99% by weight of the total composition
wherein the at least one hydrophobic component is mineral oil, vegetable oil, silicon oil, polyalphaolefins and/or mixtures thereof and comprises from 0% to 60% by weight of the total composition;
wherein the non-ionic surfactant is glycol and/or ester thereof; mono- and di-esters of fatty acids; and/or mixtures thereof; and
applying the composition to a fabric surface.

13. The method of claim 12, wherein the fabric surface is a through air dryer (TAD) fabric surface, a structured fabric surface, a papermaking belt, a textured or structured belt, a plate cylinder, a roll applicator or combinations thereof.

14. The method of claim 13, wherein the fabric surface is a TAD fabric surface.

15. The method according to claim 14, wherein the composition is applied to the fabric surface by spraying.

16. The composition according to claim 2, wherein the at least one hydrophobic component is mineral oil; vegetable oil; or mixtures thereof.

17. The composition according to claim 2, wherein the at least one hydrophobic component other than an aminoamide comprises from about 5% to about 40% based on weight of total composition.

18. The composition according to claim 2, wherein the optional non-ionic surfactant is glycol and/or ester thereof; mono- and di-esters of fatty acids; and/or mixtures thereof.

19. The composition according to claim 2, wherein the optional non-ionic surfactant comprises less than 40% by wt. of the total composition.

20. The composition according to claim 2, wherein the cyclic imidazolines between about 10% and 90% cyclized.
